(19) United States
(12) Patent Application Publication
(10) Pub. No.: US 2024/0169812 A1
(43) Pub. Date: May 23, 2024

(54) REMOTE CONTROL FINDER

(71) Applicant: Pamela Marie Thiel, Goodrich, TX (US)

(72) Inventor: Pamela Marie Thiel, Goodrich, TX (US)

(21) Appl. No.: 18/425,347

(22) Filed: Jan. 29, 2024

Related U.S. Application Data
(63) Continuation of application No. 17/588,343, filed on Jan. 31, 2022.
(60) Provisional application No. 63/170,695, filed on Apr. 5, 2021.

(51) Int. Cl. G08B 3/10; G08C 17/02

(52) U.S. Cl. CPC G08B 3/10; G08C 17/02; G08C 2201/50

(57) ABSTRACT

An apparatus for locating a misplaced remote control of a media device. The apparatus includes a transmitter unit for the media device and a receiver unit for the remote control. The receiver unit can be incorporated with the remote control and can include a buzzer. The transmitter unit can be triggered by a user for sending a signal. The receiver unit can capture the signal and upon receiving the signal triggers the buzzer. The user can follow the sound of the buzzer to locate the receiving unit and thus the remote control.

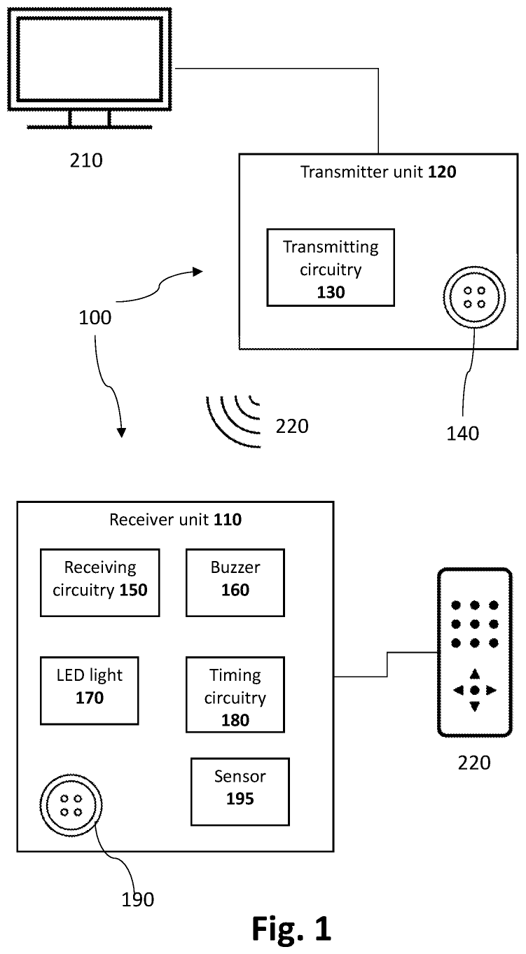

### CROSS-REFERENCE TO RELATED APPLICATIONS

This application is a continuation of a U.S. patent application Ser. No. 17/588,343, filed on Jan. 31, 2022, which claims priority from a U.S. Provisional Patent Application Ser. No. 63/170,695, filed on Apr. 5, 2021, both of which are incorporated herein by reference in its entirety.

### FIELD OF INVENTION

The present invention relates to transmitters and receivers, and more particularly, the present invention relates to an apparatus for locating misplaced remotes.

### BACKGROUND

Remote controls are one of the common electronic utilities in a household. Remote control is used to operate a media device, such as a television (TV) from a distance. For example, a user while lying on a sofa or bed can operate different features of the TV. The remote controls are compact in design and portable, that can be handled with a single hand. Remote controls have made the watching TV experience both comfortable and delightful. However, misplacing the remote controls is also a quite common problem faced by many. During everyday activities, a person can place the remove anywhere in the household other than a designated space for the remote control and forget. Finding the misplaced remote can be painful and frustrating. Often people may fail to locate the remote control in time and because of this, they can miss their favorite show.

Thus, a desire is there for a device to locate misplaced remote controls quickly and without any significant physical effort.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus to find misplaced remote controls.

Another object of the present invention is that the apparatus can be integrated into a TV and a remote control of the TV.

Still another object of the present invention is that the apparatus can be retrofitted.

Yet another object of the present invention is that the remote control can be quickly located.

It is a further object of the present invention that the user does not have to rush all over the house to locate the remote.

It is an additional object of the present invention that the remote control is economical to manufacture.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

The drawing illustrates a block diagram showing the apparatus, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The drawing illustrates the disclosed apparatus for locating remote controls. The remote controls, also referred to herein as remote, can be for media devices, such as TV, entertainment devices, and the like. Apparatus 100 includes a receiver unit 110 and a transmitter unit 120. The transmitter unit 120 can be incorporated in or on the media device 210. The transmitter unit 120 can include a transmitting circuitry 130 that can be incorporated into the media device, such as in the PCB of the media device or separate from the PCB of the media device. The transmitting circuitry 130 of the transmitter unit 120 can send a signal 220 to the receiver unit 110. The transmitter unit 120 can include a button 140 that can trigger the transmitting circuitry 130 to send the signal. The button can protrude from a casing of the media device 210, such that a user can press the button. The transmitter unit 120 can be powered by a power supply of the media device. Alternatively, a battery can be incorporated into the transmitter unit 120 for powering the transmitter unit 120.

The transmitter unit 120 can also be provided as a separate accessory that can be mounted to the casing of the media device. The transmitter unit 120 can include a housing encasing the components of the transmitter unit 120 including the battery, and the button can protrude from the housing of the transmitter unit 120. The transmitter unit 120 can be mounted to the media device 210 using an adhesive, such as a double side adhesive tape. Any other means for mounting the transmitter unit 120 to the media device is within the scope of the present invention.

The receiver unit 110 can include a receiving circuitry 150 that can receive the signal 220 from the transmitter unit 120. The transmitter unit 120 and the receiving unit 110 may be within a predefined range for the receiver unit 110 to catch the signal transmitted by the transmitter unit 120. Such a range depends upon the signal strength and can be defined based on engineering design. The receiving circuitry 150 can be connected to a buzzer 160 such that the receiving circuitry 150 upon receiving the signal from the transmitter unit 120 can trigger the buzzer 160. A LED light 170 can also be optionally provided that can blink along with the buzzer to indicate the location of the receiver unit 110, and thus the remote control. For example, the blinking LED can be specifically useful in the dark to locate the remote control 220. The receiving circuitry can also include a timing circuitry 180 that can turn off the buzzer 160 after a preset duration. The timing circuitry 180 starts upon receiving the signal 220 and can send a clock signal to the receiving circuitry 150 after the preset time, wherein the receiving circuitry 150 upon receiving the clock signal can turn off the buzzer and LED light. Also, a button 190 can be provided that can be connected to the receiving circuitry 150, such that the button 190 can be pressed to turn off the buzzer and LED light. Also, a sensor 195 can be provided that is connected to the receiving circuitry, and that can detect a motion in the remote control 220, such as the lifting of the remote control, and the sensor upon sensing the motion can send a sensor signal to the receiving circuitry 150, and the receiving circuitry 150 upon receiving the sensor signal can turn off the buzzer and LED light.

The receiving circuitry 150, the buzzer 160, and optionally the timing circuitry 180, sensor 195, and the LED light 170 can be incorporated within the remote control 220. If a button 190 is provided, the same can protrude from a casing of the remote control 220. Also, the receiver unit 110 can be mounted to the casing of the remote control 220, such as using a double side adhesive tape. The receiver unit 110 can also include a housing encasing the receiving circuitry 150, the buzzer 160, and other components of the receiver unit 110. The receiver unit 110 can be powered by the power supply of the remote control. Alternatively, a separate battery can be provided for the receiver unit 110 also encased within the housing of the receiver unit 110.

In use, the user can ensure that both the transmitter unit 120 and the receiver unit 110 are paired to each other. Suitable indicator means such as LEDs or beeps can be used to indicate the pairing and successful pairing.

Once paired, the disclosed device can allow the user to locate the misplaced remote control. The user can reach the media device, such as the TV unit mounted to a wall or a table and can then press the button of the transmitter unit 120. This triggers the receiver unit 110 coupled to the remote control to output the audio signal by the buzzer. Optionally, the LED indicator can be turned on by the receiver unit 110. The user by following the source of sound from the buzzer can locate the remote control. Blinking LED can make the process of locating the remote control quicker. In case, the receiver unit 110 has a timing circuitry, the buzzer can switch off itself after the preset time. The user can trigger the buzzer again, if required, by pressing the button of the transmitter unit 120. If the receiver unit 110 has a button, the same can be pressed by the user to switch off the buzzer. If the receiver unit 110 has a sensor, the same sense grabbing of the remote control by the user to switch off the buzzer.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for locating a remote control, the apparatus comprising:
a transmitting unit comprising:
a transmitting circuitry configured to couple to a media device, the transmitting circuitry configured to send a signal, the transmitting circuitry configured to be encased within a casing of the media device and coupled to a power supply of the media device for power, and
a first button, wherein the first button is configured to be actuated, wherein actuation of the first button causes the transmitting circuitry transmitter unit to send the signal, the first button is configured to protrude from the casing of the media device; and
a receiving unit comprising:
a receiving circuitry configured to couple to a remote control of the media device and encased within a casing of the remote control, the receiving circuitry configured to capture the signal,
a buzzer, wherein the receiving circuitry triggers the buzzer upon receiving the signal, the buzzer configured to generate a high pitch sound,
a light configured to blink,
a second button configured to protrude from the casing of the remote control, wherein actuation of the second button switches off the buzzer and the light, and
a sensor configured to detect a motion of the remote control, wherein the sensor is configured such that upon sensing the motion, the sensor sends a sensor signal to the receiving circuitry for turning off the buzzer and the light.

2. The apparatus according to claim 1, wherein the media device is a television.

3. An apparatus comprising:
a media device;
a remote control of the media device
a transmitting unit comprising:
a transmitting circuitry configured to couple to the media device, the transmitting circuitry configured to send a signal, the transmitting circuitry configured to be encased within a casing of the media device and coupled to a power supply of the media device for power, and
a first button, wherein the first button is configured to be actuated, wherein actuation of the first button causes the transmitting circuitry transmitter unit to send the signal, the first button is configured to protrude from the casing of the media device; and
a receiving unit comprising:
a receiving circuitry configured to couple to a remote control of the media device and encased within a casing of the remote control, the receiving circuitry configured to capture the signal,
a buzzer, wherein the receiving circuitry triggers the buzzer upon receiving the signal, the buzzer configured to generate a high pitch sound,
a light configured to blink,
a second button configured to protrude from the casing of the remote control, wherein actuation of the second button switches off the buzzer and the light, and
a sensor configured to detect a motion of the remote control, wherein the sensor is configured such that upon sensing the motion, the sensor sends a sensor signal to the receiving circuitry for turning off the buzzer and the light.

4. The apparatus according to claim 3, wherein the media device is a television.
